(19) United States
(12) Patent Application Publication
(10) Pub. No.: US 2010/0285692 A1
(43) Pub. Date: Nov. 11, 2010

(54) Electrical Connector Shield with Improved Grounding

(75) Inventor: Xue-Hai Zhang, Xuzhou (CN)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/223,135

(22) PCT Filed: Jan. 26, 2007
(86) PCT No.: PCT/US2007/002189

§ 371 Date: Jul. 27, 2010

(30) Foreign Application Priority Data
Jan. 26, 2006 (CN) 200620002131.4

(51) Int. Cl. H01R 13/648

(52) U.S. Cl. 439/607.01

(57) ABSTRACT

An electrical connector is connected to a mated electrical connector through an insertion interface. The electrical connector includes a shielding shell, an insulation body clad with the shielding shell, and several signal terminals received in the insulation body. The insulation body has a mating surface facing the insertion interface. The shielding shell has a first wall. Several ground terminals extend towards the direction of the insertion interface and bent towards the interior of the shielding shell from a mating side of the first wall close to the mating surface, and each ground terminal has a contact portion. Each of the ground terminals of the present invention has an elastic arm with a width nearly the same as that of the electrical connector, so as to provide enough flexibility to ensure the connection stability with the mated electrical connector, and thereby an ideal grounding effect is achieved.

### FIELD OF THE INVENTION

The present invention relates to an electrical connector, and more particularly to an electrical connector which has ground terminals, and can be connected to a counterpart.

### BACKGROUND OF THE INVENTION

As shown in FIG. 1, China Patent No. 02286721 discloses an existing electrical connector. The electrical connector includes an insulation body 7, a shielding shell 8, and several signal terminals C received in the insulation body 7.

The insulation body 7 includes a base 70 and a mating portion 71 vertically extending from a side of the base 70 in the longitudinal direction. One surface of the base 70 from where the mating portion 71 extends is a mating surface 700. Several receiving slots 701 penetrate through the other side of the base 70 opposite the mating portion 71, and several accommodation slots 710 are disposed on a side wall of the mating portion 71 facing the receiving slot 701, and each accommodation slot 710 integrally penetrates through the base 70. Each signal terminal C is inserted in the corresponding accommodation slot 710.

The shielding shell 8 covers the external surface of the insulation body 7, and has a first retaining wall 80 and a second retaining wall 81 that are parallel to each other. The second retaining wall 81 has an abutting surface 810 that can abut against the mating surface 700 of the insulation body 7. The abutting surface 810 has a pin 811 at a position corresponding to the receiving slot 701 of the insulation body 7 reversely extending towards the insulation body 7, so as to be inserted in the receiving slot 701, and thereby the shielding shell 8 is joined to the insulation body 7. The second retaining wall 81 has several rectangular windows 812 disposed along a longitudinal direction at positions corresponding to the receiving slot 701 of the insulation body 7, and each window 812 has a cantilever-shaped ground terminal G extending from a side wall of the abutting surface 810 and away from the abutting surface 810. The ground terminal G extends towards the retaining wall 80 at a certain angle as a whole, and the free end of the ground terminal G has a guide portion G protruding towards the first retaining wall 80 direction, so as to mate with the ground terminal (not shown) of the other electrical connector.

The ground terminal G is integrally formed by slantingly extending from the shielding shell 8, and hence, it is easily completed. However, it extends from the sidewall of the window 812 so that the cantilever is too short. Therefore, the ground terminal connected with the mated electrical connector has insufficient elasticity, and it is difficult to keep the connection stable. Apparently, the existing electrical connector still needs to be improved, so as to achieve a more preferred ground effect.

### SUMMARY OF THE INVENTION

The present invention provides an electrical connector, which has a sufficient elasticity when a ground terminal of the electrical connector is connected with a ground terminal of a mated electrical connector, thus keeping the connection stable.

The present invention provides an electrical connector, applicable for the connection with a mated electrical connector through an insertion interface. The electrical connector includes a shielding shell, an insulation body clad with the shielding shell, and several signal terminals received in the insulation body. The insulation body has a mating surface facing the insertion interface. The shielding shell has a first wall. Several ground terminals extend towards the direction of an insertion interface and bent towards the interior of the shielding shell from a mating side of the first wall close to the mating surface, and each ground terminal has a contact portion on the free end.

In an embodiment, several auxiliary ground terminals are bent and extend towards the mating side from a side opposite the mating side of the first wall, and each ground terminal has a contact portion. The contact portions of the ground terminals and the auxiliary ground terminals are alternately arranged in a horizontal direction. A window is disposed in the first wall of the shielding shell corresponding to the contact portion of each ground terminal. At least one retaining plate extends towards the interior of the shielding shell from one side of the shielding shell close to the insertion interface. A fixing portion capable of fixing the shielding shell on the circuit board is respectively bent and extends from two sides of the shielding shell. In an embodiment, a ground welding pin is integrally bent and extending respectively from two ends of the shielding shell. In another embodiment, the shielding shell has separated ground welding pins, each of which has a retaining portion, a rear portion extending from one side of the retaining portion, and a contact portion bent and extending from the side of the retaining portion to the direction of an opposite side and contacting the shielding shell. A protection body is disposed on the first wall and extends along one side of each ground terminal. The height of each protection body is lower than that of the contact portion of each ground terminal, and one end of each protection body facing the insertion interface is closer to the insertion interface than the free end of the ground terminal.

Compared with the conventional art, in the electrical connector of the present invention, the ground terminals extend from the mating side of the first wall, and an elastic arm is long enough to provide a sufficient elasticity to a maximum extent for maintaining a stable electrical connection when the ground terminals are connected with the mated electrical connector. Meanwhile, the auxiliary ground terminals further enhance the stable connection state, so as to achieve a more preferred grounding effect.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is an exploded stereogram of an existing electrical connector in the conventional art;

FIG. 2 is a stereogram of an electrical connector according to an embodiment of the present invention;

FIG. 3 is an exploded view of the electrical connector in FIG. 2;

FIG. 4 is a partially exploded view of the electrical connector in FIG. 2;

FIG. 5 is a bottom view of the electrical connector in FIG. 2;

FIG. 5(a) is a cross-sectional view of the electrical connector in FIG. 5 along the line of AA;

FIG. 5(b) is a cross-sectional view of the electrical connector in FIG. 5 along the line of BB;

FIG. 6 is a top view of the electrical connector in FIG. 2;

FIG. 6(a) is a cross-sectional view of the electrical connector in FIG. 6 along the line of CC;

FIG. 6(b) is a cross-sectional view of the electrical connector in FIG. 6 along the line of DD;

FIG. 7 is an exploded stereogram of an electrical connector according to another embodiment of the present invention;

FIG. 8 is a stereogram of the electrical connector in FIG. 7 mounted on a circuit board;

FIG. 9 is a top view of the electrical connector in FIG. 7;

FIG. 9(a) is a cross-sectional view of the electrical connector in FIG. 9 along the line of EE;

FIG. 10 is a stereogram of an electrical connector according to another embodiment of the present invention; and

FIG. 11 is a stereogram of an electrical connector according to another embodiment of the present invention.

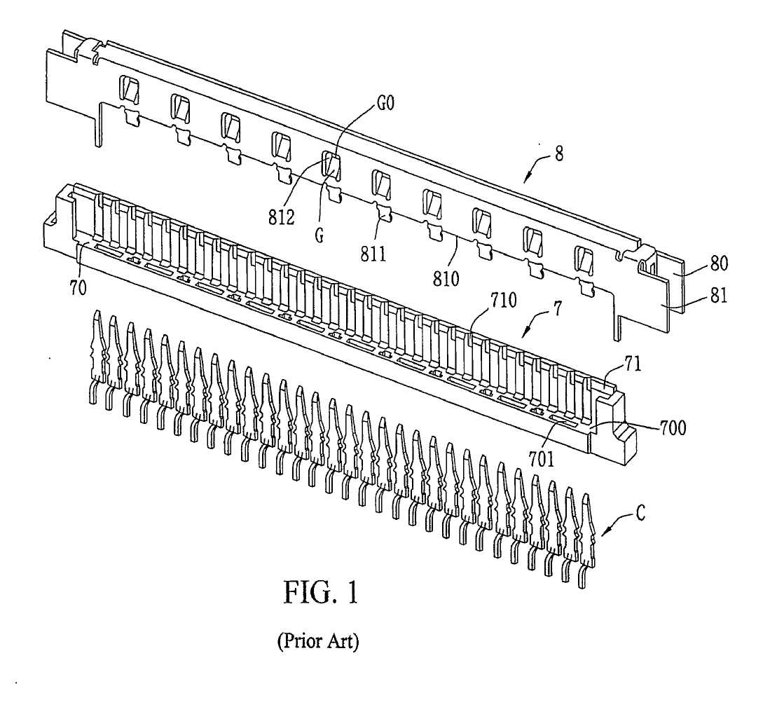

### DETAILED DESCRIPTION OF THE PREFERRED EMBODIMENTS

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

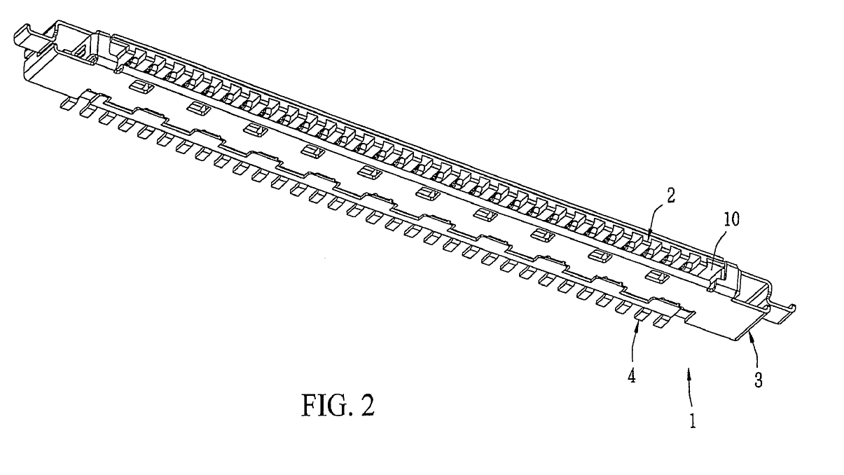

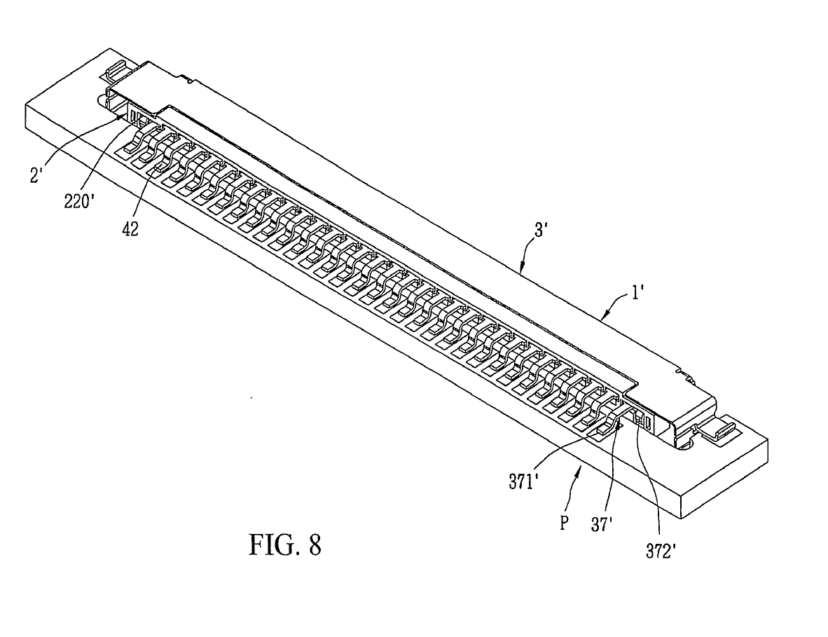

Referring to FIG. 2, an electrical connector 1 according to an embodiment of the present invention includes an insulation body 2, a shielding shell 3 for covering the insulation body 2 and several signal terminals 4 received in the insulation body 2. The electrical connector 1 according to the present invention can be further disposed on a circuit board P (referring to FIG. 8), for a mated electrical connector (not shown) to be connected through an insertion interface 10, so as to achieve signal transmission between each other.

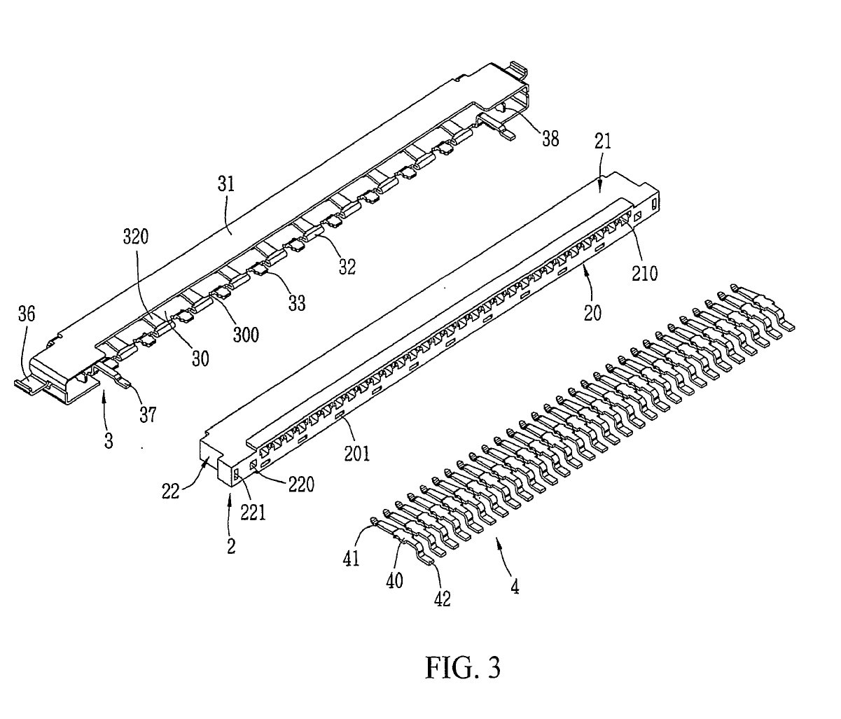

As shown in FIGS. 3, 4, 5, 5(a), and 5(b), the insulation body 2 of the electrical connector 1 according to an embodiment of the present invention includes a rectangular base 20 and a mating portion 21 vertically extending from a side of a mating surface 200 of the base 20. The mating surface 200 is one surface of the electrical connector 1 facing the insertion interface. Several first retaining slots 201 penetrating to the opposite surface are disposed on the mating surface 200 with respect to one side in order to extend the mating portion 21. A groove 202 is formed on the mating surface 200 between the adjacent first retaining slots 201. Several terminal receiving slots 210 are disposed on the side wall of the mating portion 21 close to the first retaining slot 201. The terminal receiving slot 210 extends vertically to the mating surface 200, and integrally penetrates through the base 20. Additionally, a trapezoidal portion 22 protrudes on the two side surfaces respectively of the short side of the base 20 and the mating portion 21. An accommodation slot 220 and a second retaining slot 221 extend on each trapezoidal portion 22 in the same direction as the first retaining slot 201, and the second retaining slot 221 is located on the external side.

Each signal terminal 4 can be received in the corresponding terminal receiving slot 210, which has a retaining portion 40, and a connection portion 41 and a rear portion 42 extending from two opposite ends of the retaining portion 40. The retaining portion 40 can be mated and interfered with the inner wall of the terminal receiving slot 210, so as to retain the signal terminal 4 in the terminal receiving slot 210. The connection portion 41 can be electrically connected to the mated electrical connector. The rear portion 42 can be welded to the circuit board P, so that not only is the electrical connector 1 fixed on the circuit board P, but also the electrical connection is between each other (referring to FIG. 8).

The shielding shell 3 has a first wall 30 and a second wall 31 opposite the first wall 30. One side of the first wall 30 close to the mating surface 200 of the insulation body 2 is a mating side 300, and several ground terminals 32 extend from a position of the mating side 300 corresponding to the groove 202 of the insulation body 2. The ground terminal 32 is bent towards the interior of the shielding shell 3 from the mating side 300 and extends towards the insertion interface, which has a sufficiently long elastic arm 320 and a contact portion 321 formed at its free end and protruding towards the second wall 31. The contact portion 321 can contact the ground terminal of the mated electrical connector. Corresponding to the contact portion 321, several windows 301 are formed on the first wall 30, so as to provide sufficient connection spaces. At the side of each ground terminal 32, several retaining portions 33 are approximately horizontally protruding from the mating side 300 of the first wall 30. Each retaining portion 33 can be received in the corresponding first retaining slot 201 of the insulation body 2, and thereby the shielding shell 3 and the insulation body 2 are combined together.

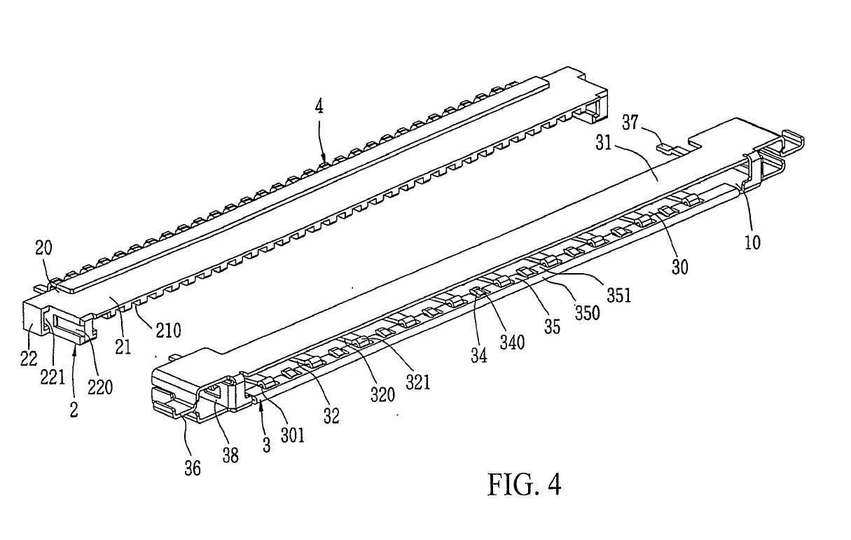

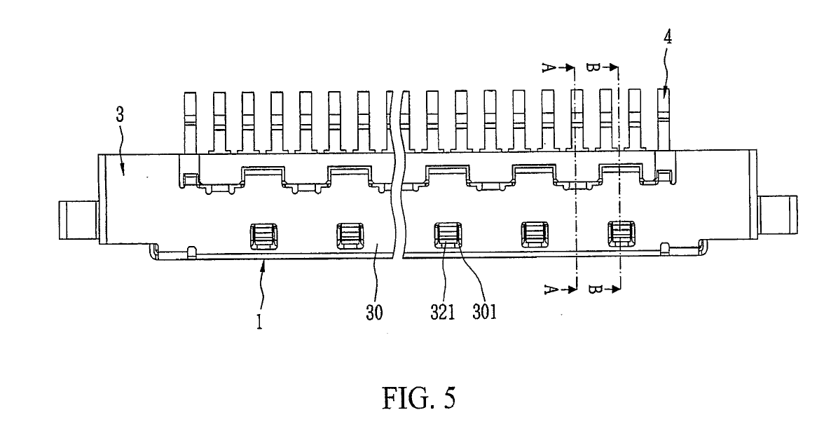

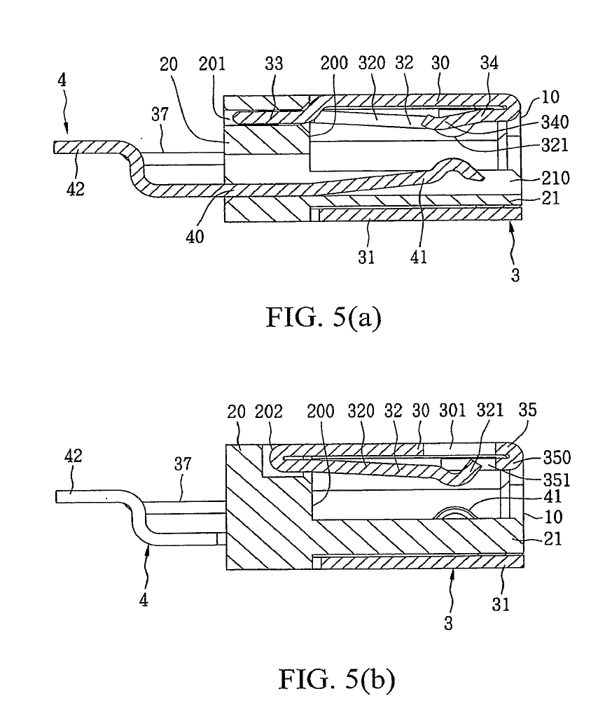

In order to enhance the grounding effect during the connection between the electrical connector 1 and the mated electrical connector, several auxiliary ground terminals 34 corresponding to the retaining portions 33 are bent and extend towards the mating side 300 from the opposite side of the mating side 300 of the first wall 30. A contact portion 340 is formed on the free end of the auxiliary ground terminal 34, and the contact portion 340 and the contact portion 321 of the ground terminal 32 are alternately arranged in a horizontal direction. In addition to the connection with the ground terminal of the mated electrical connector, the contact portion 340 is used to guide the mated electrical connector to connect to the electrical connector 1. As shown in FIGS. 4, and 5(b), in this embodiment, on one side of each ground terminal 32 and the auxiliary ground terminal 34, several protection bodies 35 protrude toward the inner part of the shielding shell 3 from the first wall 30. The protection body 35 is bent backwards from one side of the first wall 30 close to the insertion interface 10 towards the mating side 300. Each protection body 35 has a guide portion 350 bent towards one side close to the insertion interface 10, and a stopping portion 351 extends horizontally towards the mating side 300 from the guide portion 350. The guide portion 350 on the front end of the protection body 35 is closer to the insertion interface 10 than the contact portion 321 of each ground terminal 32, and the height of the stopping portion 351 is lower than that of the contact portions 321, 340 of each ground terminal 32 and the auxiliary ground terminal 34. Thus, when the mated electrical connector is inserted into the electrical connector 1 through the insertion interface 10, the mated electrical connector is firstly raised by the guide portion 350 of the protection body 35, so as to avoid pressing and damaging the ground terminal 32 and the auxiliary ground terminal 34 due to its excessively low position. When the mated electrical connector is connected with the electrical connector 1 according to the present invention, due to the height restriction of the stopping portion 351, the contact portions 321, 340 of each ground terminal 32 and auxiliary ground terminal 34 of the electrical connector 1 are at most pushed to a height equal to that of the stopping portion 351, and thus avoid being pressed excessively and deformed permanently.

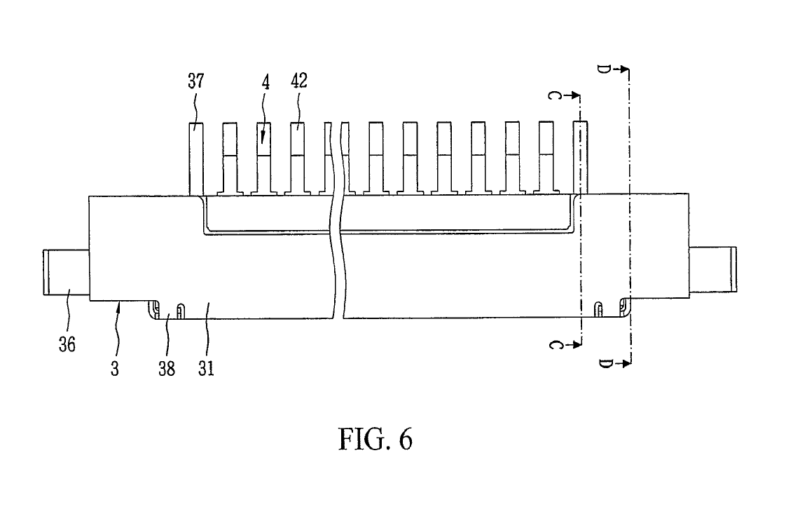

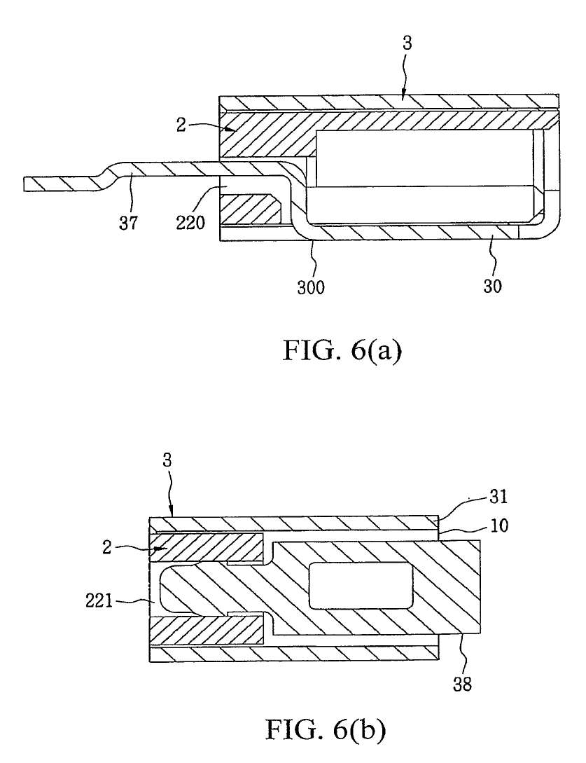

Additionally, referring to FIGS. 3, 4, 6, and 6(a), in order to fix the shielding shell 3 on the circuit board P, a fixing portion 36 is bent and extends from two ends of the second wall 31 (or the first wall 30) of the shielding shell 3, and a ground welding pin 37 is integrally bent and extends from two ends of the mating side 300 of the first wall 30 respectively, which can be accommodated in the accommodation slot 220 of the insulation body 2. The free ends of the fixing portion 36 and the ground welding pin 37 and the rear portion 42 of the signal terminal 4 are located at the same level, and thereby they can be welded on the circuit board P together. Referring to FIGS. 3, 4, 6, and 6(b), corresponding to the second retaining slot 221 of the insulation body 2, a retaining plate 38 respectively extends towards the interior of the shielding shell 3 from two ends of the shielding shell 3 close to the insertion interface 10, and the retaining plate 38 is mated and interfered with the second retaining slot 221 through two sides, and thereby the shielding shell 3 and the insulation body 2 are further held together.

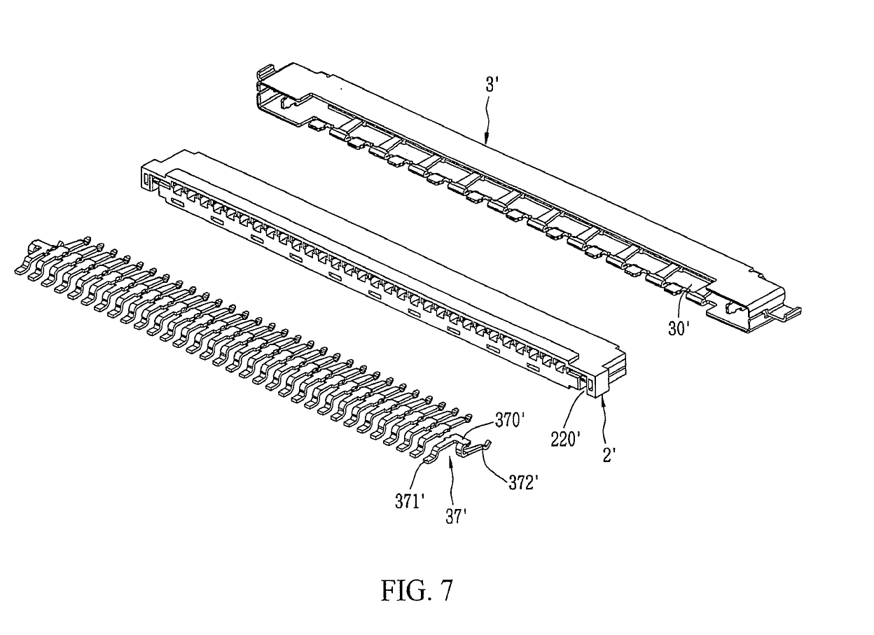

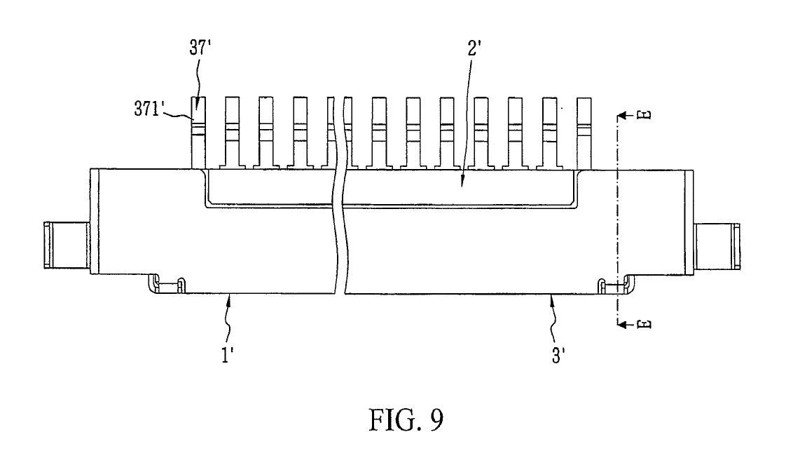

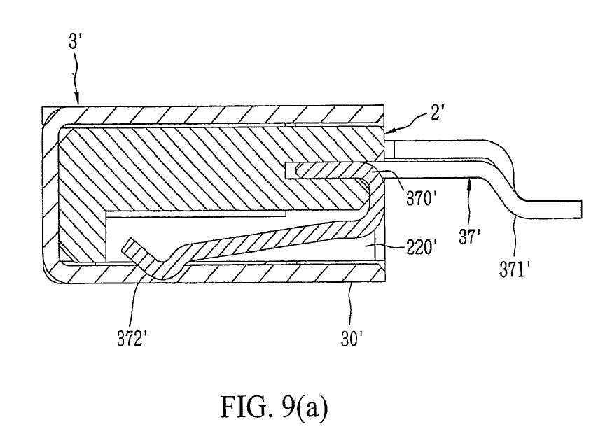

As shown in FIGS. 7, 8, 9, and 9(a), in another embodiment of the present invention, ground welding pins 37′ of an electrical connector 1′ are independent and individual terminals, rather than an integral terminal extending from a shielding shell 3′. The ground welding pin 37′ has a retaining portion 370′, a rear portion 371′ extending from a side of the retaining portion 370′, and a contact portion 372′ bent from the side of the retaining portion 370′ and extending towards the opposite side. The rear portion 371′ can be welded on the circuit board P, and the contact portion 372′ can abut the first wall 30′ of the shielding shell 3′. Accordingly, an accommodation slot 220′ on the insulation body 2′ should also be designed into a structure with an opening on one side according to the structural design of the ground welding pin 37′.

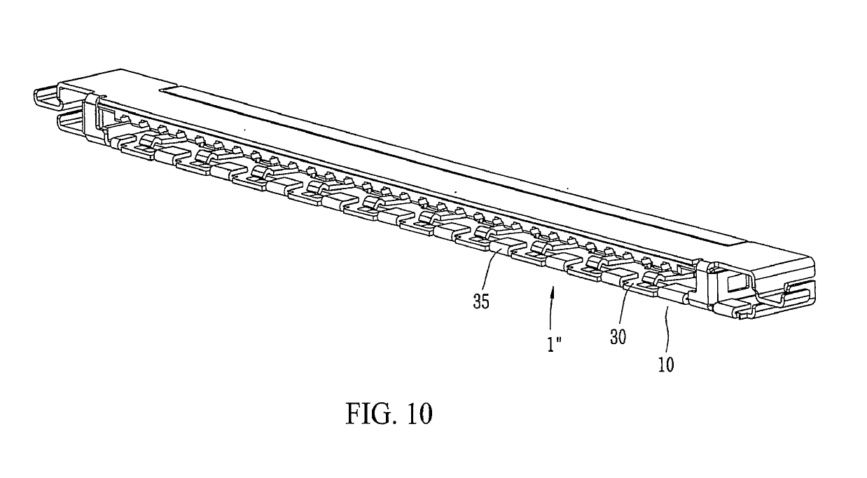

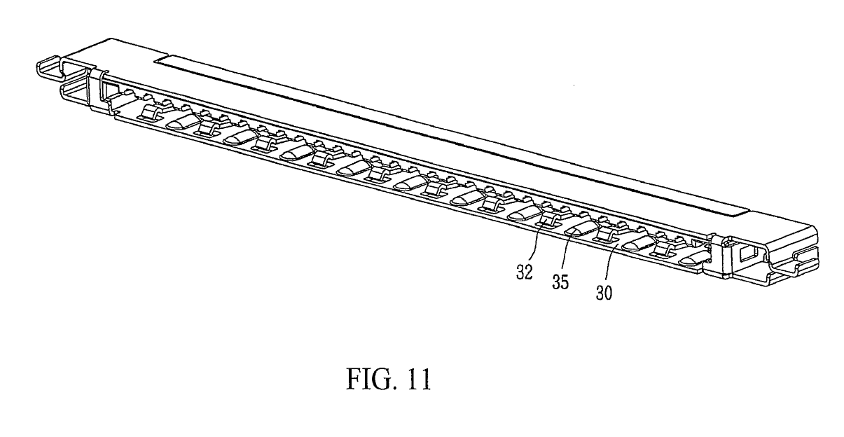

The present invention has different embodiments corresponding to different structures of the mated electrical connector. As shown in FIG. 10, according to another embodiment of the present invention, an electrical connector 1″ has no auxiliary ground terminal on the first wall 30. Each protection body 35 is bent backwards from one end of the first wall 30 close to the insertion interface 10 towards the side of each ground terminal. As shown in FIG. 11, according to yet another embodiment of the present invention, similarly, no auxiliary ground terminal is disposed on the first wall 30, and each protection body 35 is directly formed on the first wall 30 into a configuration of a semi-cylinder-shaped block protruding from and extending along one side of each ground terminal 32. All the above modifications and simple variations fall into the scope of protection of the present invention.

The electrical connector according to the present invention has a ground terminal bent from the mating side of the first wall into the interior of the shielding shell and extending towards a direction of the insertion interface. The length of the elastic arm is substantially the same as that of the electrical connector, and the elasticity of the elastic arm is superior to that of the existing ground terminal extending from the window Therefore, stable contacts exist between the electrical connector and the mated electrical connector when they are connected to each other. Additionally, the auxiliary ground terminal further enhances the grounding effect during the connection.

While a preferred embodiment of the invention is shown and described, it is envisioned that those skilled in the art may devise various modifications without departing from the spirit and scope of the foregoing description and the appended claims.

What is claimed is:

1. An electrical connector connected to a mated electrical connector through an insertion interface, comprising a shielding shell, an insulation body covered by the shielding shell, and several signal terminals received in the insulation body, wherein the insulation body has a mating surface facing the insertion interface and the shielding shell has a first wall, characterized in that several ground terminals extend towards the insertion interface and are bent towards the interior of the shielding shell from a mating side of the first wall adjacent to the mating surface, and each of the ground terminals has a contact portion formed at a free end.

2. The electrical connector of claim 1, further comprising several auxiliary ground terminals extending and bent towards the mating side of the first wall from a side opposite the mating side, wherein each of the auxiliary ground terminals has a contact portion.

3. The electrical connector of claim 2, wherein the contact portions of the ground terminals and the contact portions of the auxiliary ground terminals are alternately arranged in a horizontal direction.

4. The electrical connector of claim 1, wherein the first wall of the shielding shell has a window disposed on a location corresponding to the contact portion of the ground terminal.

5. The electrical connector of claim 1, further comprising at least one retaining plate retained on the insulation body extending towards the interior of the shielding shell from one of two ends of one side of the shielding shell adjacent to the insertion interface.

6. The electrical connector of claim 1, further comprising a fixing portion bent and extending respectively from each of two ends of the shielding shell for fixing the shielding shell to a circuit board.

7. The electrical connector of claim 1, further comprising a ground welding pin integrally bent and extending respectively from each of two ends of the shielding shell.

8. The electrical connector of claim 1, wherein the electrical connector has at least one ground welding pin separated from the shielding shell and each ground welding pin has a retaining portion, a rear portion extending from one side of the retaining portion and a contact portion bent and extending from the same side of the retaining portion to an opposite side.

9. The electrical connector of claim 1, further comprising protection bodies disposed on the first wall and extending along one side of each ground terminal.

10. The electrical connector of claim 9, wherein the height of each of the protection bodies is lower than the height of the contact portion of each of the ground terminals, and one end of each of the protection bodies facing the insertion interface is closer to the insertion interface than the free end of each of the ground terminals.

11. The electrical connector of claim 10, wherein each of the protection bodies has a column block directly protruding from the first wall and extending along one side of each of the ground terminals.

12. The electrical connector of claim 10, wherein each of the protection bodies is respectively bent backwards from one end of the first wall close to the insertion interface to reach one side of each of the ground terminals.
